(19) United States
(12) Patent Application Publication
(10) Pub. No.: US 2020/0152401 A1
(43) Pub. Date: May 14, 2020

(54) ELECTRONIC DEVICE AND BUTTON STRUCTURE

(71) Applicant: PEGATRON CORPORATION, Taipei City (TW)

(72) Inventors: Ching-Yen HUANG, Taipei City (TW); Hui Chen WANG, Taipei City (TW); Yi-Chun TANG, Taipei City (TW); Hung-Yun WU, Taipei City (TW); Hsiao-Fan CHEN, Taipei City (TW)

(21) Appl. No.: 16/522,513

(22) Filed: Jul. 25, 2019

(30) Foreign Application Priority Data
Nov. 13, 2018 (TW) 107140232

(51) Int. Cl. H01H 13/06; H01H 13/14; H01H 13/02

(52) U.S. Cl. CPC H01H 13/06; H01H 13/023; H01H 13/14

(57) ABSTRACT

An electronic device includes a housing, a button structure, a switch, and a water-proof adhesive. The housing has an opening. The button structure is disposed at the opening and includes a button body and an elastic body. The button body is exposed from the opening. The elastic body and the button body is integrally formed as a single component. The elastic body is configured to provide the button body with a recovery force when being pressed. The switch is disposed relative to a position of the button body and is electrically coupled to a circuit board to generate a switching signal when the button body is pressed. The water-proof adhesive is disposed between an inner surface of the housing and the elastic body, and surrounds the opening.

### BACKGROUND

### Technical Field

The disclosure relates to an electronic device and a button structure, and in particular, to a dustproof and waterproof electronic device and a button structure.

### Related Art

Nowadays, a button switch or an input element of an electronic device is not designed with a waterproof and dustproof function, and therefore internal elements of the electronic device are likely to be broken or short-circuited due to moisture or dust, and consequently cannot be used normally. In order to prevent the electronic device from being damp and dusty, a user usually covers the button switch with waterproof cloth to achieve a waterproof and dustproof effect. However, the waterproof cloth is likely to affect an overall appearance of the electronic device, a sense of touch of the button switch, and a shape or a pattern of the button switch body.

Therefore, how to provide an electronic device and a button structure to prevent dust or moisture from entering the electronic device via the button structure has become an important issue.

### SUMMARY

In view of the foregoing issue, a purpose of the disclosure is to provide a button structure capable of preventing dust or moisture from entering an electronic device via the button structure.

In order to achieve the foregoing purpose, the disclosure provides an electronic device, including a housing, a button structure, a switch, and a waterproof adhesive. The housing has an opening. The button structure is disposed at the opening and includes a button body and an elastic body. The button body is exposed from the opening. The elastic body and the button body are integrally formed as a single component and the elastic body is configured to provide the button body with a recovery force when being pressed. The switch is disposed relative to the button body, the switch being electrically coupled to a circuit board to generate a switching signal when the button body is pressed. The water-proof adhesive is disposed between an inner surface of the housing and the elastic body, and surrounds the opening.

The disclosure further provides a button structure disposed at an opening of an electronic device, the button structure including a button body and an elastic body, the button body being exposed from the opening, and the elastic body and the button body being integrally formed as a single component.

As described above, in the disclosure, the waterproof adhesive is disposed between the inner surface of the housing of the electronic device and the elastic body and is surrounding the opening. Therefore, even if dust or moisture passes through a gap between the button body and the housing of the electronic device from an external environment, dust or moisture cannot enter into the housing of the electronic device, so as to achieve a waterproof and dustproof effect.

In addition, the elastic body and the button body of the button structure may be integrally formed by double injection. Accordingly, even if the elastic body and the button body are made of different materials, for example, the elastic body is made of a soft material and the button body is made of a light-transmissive plastic material, the elastic body and the button body can still be tightly combined. Moreover, since the elastic body and the button body can be tightly combined without an additional adhesive, an overall stack of the button structure is relatively thin, thereby saving space.

### BRIEF DESCRIPTION OF THE DRAWINGS

FIG. 1 is a schematic three-dimensional view of a button structure and an electronic device according to an embodiment.

FIG. 2A is a schematic exploded view of a button structure according to an embodiment.

FIG. 2B is a schematic view of another perspective of a button body in FIG. 2A.

FIG. 3 is a schematic exploded view of an electronic device according to an embodiment.

FIG. 4 is a schematic three-dimensional profile view of an electronic device according to an embodiment.

FIG. 5 is a schematic three-dimensional local view of a housing of an electronic device according to an embodiment.

### DETAILED DESCRIPTION

An electronic device and a button structure according to a preferred embodiment of the disclosure are described with reference to related drawings. Same elements are described with same reference numerals.

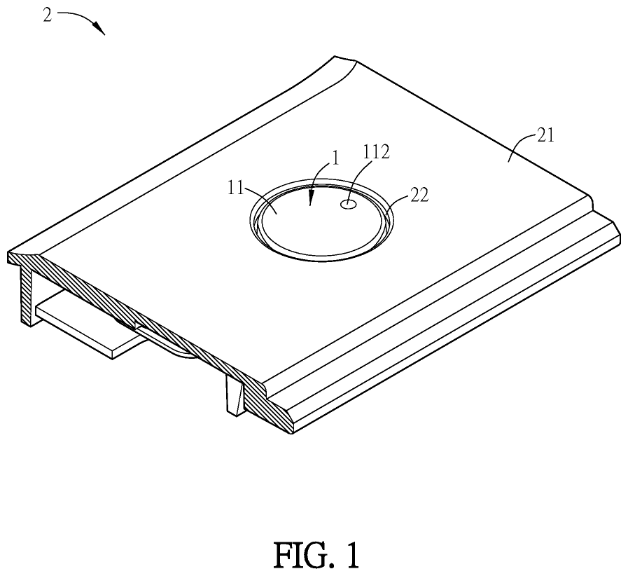

FIG. 1 is a schematic three-dimensional view of a button structure and an electronic device according to an embodiment. As shown in FIG. 1, a button structure 1 is disposed at an opening 22 of a housing 21 of an electronic device 2, a button body 11 of the button structure 1 is exposed from the opening 22 for a user to press, and some elements of the button structure 1 are disposed on an inner surface of the housing 21. In some embodiments, the button structure 1 is disposed in the electronic device 2, and the electronic device 2 is, for example but not limited to, a server, a desktop, a notebook, a tablet, a media player, a TV game, a radio telephone, a mobile communication device, a home appliance, a power supply, a power switch, a function shifting switch, other types of computer devices, other types of communication devices, or other types of switches, etc. The button structure 1 is used as, for example but not limited to, a power button, a switch button, or other function buttons. For ease of illustration, only a local structure related to installation of the button structure 1 is depicted in the housing 21 in the figure.

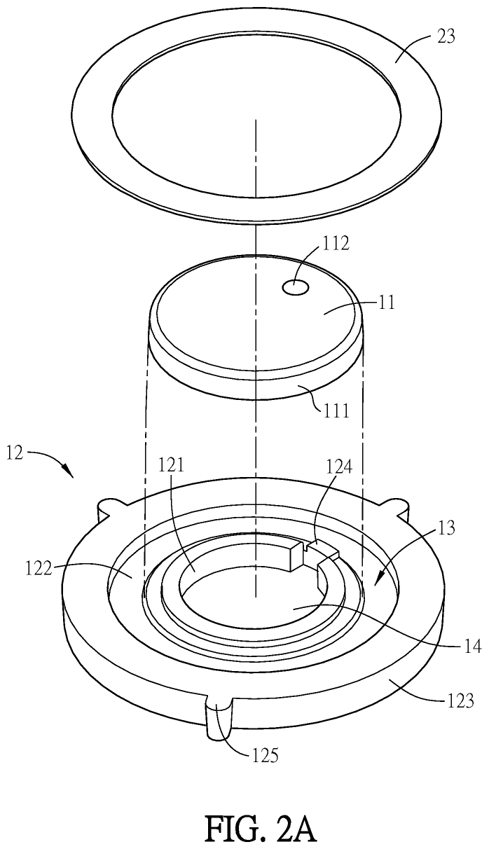

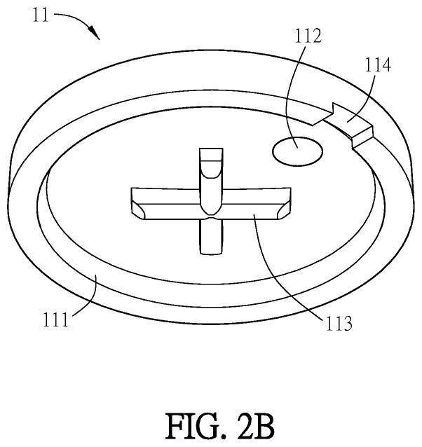

FIG. 2A is a schematic exploded view of a button structure according to an embodiment. As shown in FIG. 2A, the electronic device 2 includes the button structure 1 and a waterproof adhesive 23.

In some embodiments, the waterproof adhesive 23 is annular and is configured to connect the button structure 1 to the housing 21 of the electronic device 2, so as to prevent moisture or dust from entering into the electronic device 2.

In some embodiments, the button structure 1 includes a button body 11 and an elastic body 12. The elastic body 12 and the button body 11 are separately depicted in FIG. 2A for ease of explanation, and are actually an integrally formed single component. In some embodiments, the elastic body 12 and the button body 11 may be made of different materials and integrally formed as a single component by double injection, so that the elastic body 12 can provide the button body 11 with a recovery force when being pressed. For example, the elastic body 12 may be made of a soft material, in which the soft material is, for example, thermoplastic polyurethane or other soft materials. The button body 11 may be made of a light-transmissive plastic material, in which the light-transmissive plastic material is, for example, polycarbonate or other light-transmissive plastic materials. Integration by double injection is, for example, to inject two different plastic materials or resins into a mold in an order for molding, which can improve a bonding strength between the two different materials. Moreover, since the elastic body 12 and the button body 11 are integrally formed without an assembly tolerance, an overall stack of the button structure 1 may be relatively thin in order to save space.

In some other embodiments, the elastic body 12 and the button body 11 may be bonded using an adhesive, for example, a gum.

In some embodiments, the elastic body 12 includes a body portion 121, an elastic arm 122, and an outer edge portion 123, in which the body portion 121 carries the button body 11, the elastic arm 122 connects to the body portion 121, the outer edge portion 123 connects to the other side of the elastic arm 122 relative to the body portion 121, and the outer edge portion 123 connects to the inner surface of the housing 21 via the waterproof adhesive 23. In some embodiments, the elastic arm 122 and the outer edge portion 123 are annular and surround the body portion 121, top faces of the outer edge portion 123 and the elastic arm 122 forms a groove 13 with the button body 11, and the groove 13 and a top face of the button body 11 face a same direction (that is, face an outer surface of the housing 21). Both face upward in FIG. 2A. In some embodiments, the top face of the elastic arm 122 may include an annular inclined plane that extends obliquely toward a bottom end of the outer edge portion 123 from a top end near the body portion 121. In some embodiments, an inner hole 14 is formed in the body portion 121, and the button body 11 connects to the top face of the body portion 121 and covers the inner hole 14.

In some embodiments, the button body 11 may include a flange 111, a side face of the flange 111 connects to an outer side face of the body portion 121, and an inner face of the button body 11 connects to the top face of the body portion 121. A bottom face of the flange 111 may also connect to a part of the top face of the elastic arm 122, and the button body 11 and the elastic body 12 may be tightly combined through integration at a junction of the foregoing both.

FIG. 2B is a schematic view of another perspective of the button body in FIG. 2A. In particular, FIG. 2B is a schematic view of a bottom perspective of the button body 11. As shown in FIG. 2B, the button body 11 includes at least one light-transmissive pattern 112, a convex portion 113, and a positioning portion 114, in which the protrusion 113 is located in the inner hole 14. The positioning portion 114 and a positioning portion 124 of the elastic body 12 (shown in FIG. 2A) have shapes matched with each other, and connect to each other to fix the button body 11 on the elastic body 12. The light-transmissive pattern 112 is formed, for example, through printing, screen printing, or spraying. For example, outside an area of the light-transmissive pattern 112 on the top face of the button body 11, a light-proof material is printed, screen-printed, or sprayed, so that when a light is emitted from the button body 11, the light-transmissive pattern 112 is formed. In some embodiments, the protrusion 113 is crosswise-shaped, but the disclosure is not limited thereto.

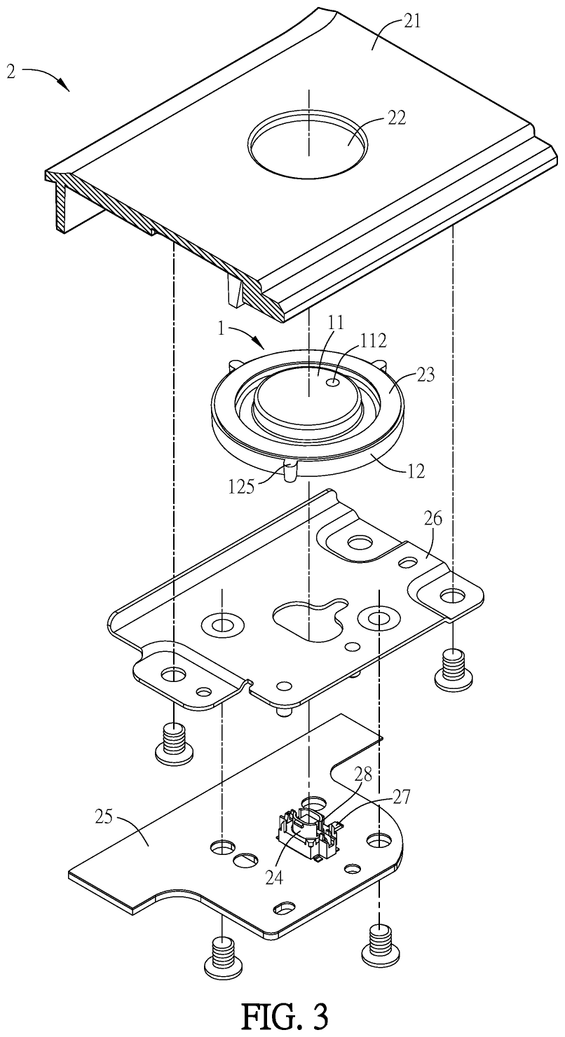

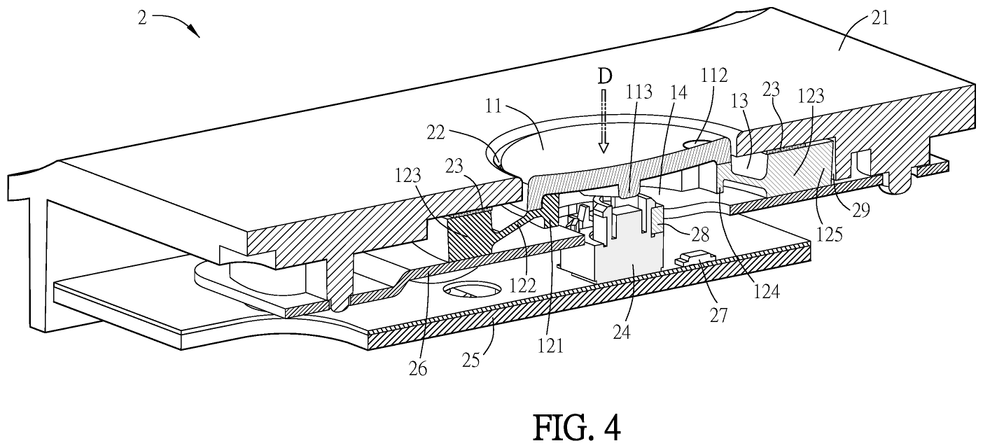

FIG. 3 is a schematic exploded view of an electronic device according to an embodiment, and FIG. 4 is a schematic three-dimensional profile view of an electronic device according to an embodiment. As shown in FIG. 3 and FIG. 4, the electronic device 2 includes a housing 21, a button body 11, an elastic body 12, a groove 13, an opening 22, a waterproof adhesive 23, a switch 24, and a circuit board 25, in which the switch 24 is disposed relative to a position of the button body 11 and electrically coupled to the circuit board 25, the waterproof adhesive 23 is disposed between an inner surface of the housing 21 and the elastic body 12 and surrounds the opening 22, and the groove 13 is disposed between the elastic body 12 and the inner surface of the housing 21, and in communication with the opening 22. Thereby, Since the groove 13 faces the inner surface of the housing 21 and communicates with the opening 22, even if dust or moisture passes through a gap of the opening 22 between the button body 11 and the housing 21 from an external environment, dust or moisture may still remain in the groove 13, thereby preventing dust or moisture from continually entering more deeply into the housing 21 via the groove 13.

In some embodiments, the switch 24, the body portion 121 of the elastic body 12, and the button body 11 are disposed relative to each other. For example, central axes of the button body 11, the body portion 121, and the switch 24 are aligned, and the protrusion 113 of the button body 11 in the inner hole 14 is aligned with the switch 24. Accordingly, the button body 11 touches the switch 24 when moving toward the switch 24 along a direction D when being pressed, and the switch 24 may generate a switching signal and transmit the switching signal to a processor (not shown) through the circuit board 25 for signal processing.

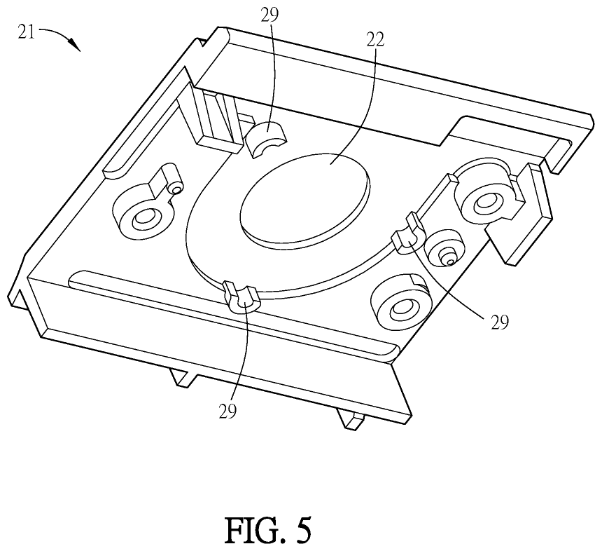

In some embodiments, the electronic device 2 further includes a fixing element 26, in which the fixing element 26 is fixed on the housing 21 through, for example, screw. The fixing element 26 abuts against the button structure 1. In particular, the outer edge portion 123 of the elastic body 12 of the button structure 1 is sandwiched between the fixing element 26 and the housing 21, thereby fixing a position of the button structure 1. In some embodiments, the elastic body 12 may include at least one positioning structure 125, in which the positioning structure 125 is, for example, a bump. The housing 21 may be provided with a positioning hole 29, and the positioning structure 125 may be interlocked with the positioning hole 29 on the housing 21, so as to install the button structure 1 on the housing 21 properly. For example, as shown in FIG. 3 and FIG. 5, FIG. 5 is a schematic three-dimensional local view seen from the inner surface of the housing 21. The elastic body 12 includes three positioning structures 125 interlocked with three positioning holes 29 on the housing 21 respectively, so that no directional error occurs during assembly of the button structure 1.

In some embodiments, as shown in FIG. 3, the electronic device 2 further includes a light-emitting element 27, in which the light-emitting element 27 is electrically coupled to the circuit board 25. A light emitted from the light-emitting element 27 passes through the light-transmissive pattern 112 on the button body 11 via the inner hole 14, so that a user can see the light-transmissive pattern 112. In some other embodiments, the electronic device 2 further includes a light-emitting element 28 in addition to the light-emitting element 27, in which the light-emitting element 28 is disposed on the switch 24 to enhance an intensity of the light emitted from the light-transmissive pattern 112.

In some embodiments, the button structure 1 may be assembled on a planar or non-planar area of the housing 21, and a layout, an arrangement, and an appearance of the button structure 1 may be arbitrarily changed according to actual requirements, but the disclosure is not limited thereto.

In actual applications, the body portion 121 and the button body 11 connected to the body portion 121 move toward the direction D when being pressed, and may squeeze the elastic arm 122 during movement. When the button body 11 has been displaced toward the direction D and is no longer pressed, the elastic arm 122 provides an elastic recovery force to the body portion 121 and the button body 11 because of being squeezed, so that the body portion 121 and the button body 11 may move toward a direction opposite to the direction D and return to an original position.

In summary, in the button structure 1 of the disclosure, since the top surfaces of the outer edge portion 123 and the elastic arm 122 form the groove 13, even dust or moisture passes through the gap between the button body 11 and the housing 21 of the electronic device 2 from the external environment, dust or moisture may remain in the groove 13. Moreover, since the outer edge portion 123 of the button structure 1 is bonded to the housing 21 of the electronic device 2 using the waterproof adhesive 23, dust or moisture can thereby be prevented from continually entering into the housing 21 of the electronic device 2 from the groove 13.

In addition, the elastic body 12 and the button body 11 of the button structure 1 may be integrally formed by double injection. Accordingly, even if the elastic body 12 and the button body 11 are made of different materials, for example, the elastic body 12 is made of a soft material and the button body 11 is made of a light-transmissive plastic material, the elastic body 12 and the button body 11 can still be tightly combined. Since the elastic body 12 and the button body 11 can be tightly combined without an additional adhesive, a stack on the button structure is relatively thin on the whole to save space. Furthermore, since the elastic body 12 and the button body 11 are integrally formed by double injection, a set of molds may be saved.

The foregoing descriptions are merely examples but are not for limiting. Any equivalent modification or change to the disclosure without departing from a spirit and scope thereof are intended to be included in appended claims.

What is claimed is:

1. An electronic device, comprising:
a housing having an opening;
a button structure disposed at the opening, and the button structure comprising:
a button body exposed from the opening; and
an elastic body integrally formed with the button body as a single component and is configured to provide the button body with a recovery force when being pressed;
a switch disposed relative to a position of the button body, and the switch electrically coupled to a circuit board to generate a switching signal when the button body is pressed; and
a water-proof adhesive disposed between an inner surface of the housing and the elastic body, and surrounding the opening.

2. The electronic device according to claim 1, wherein the button body and the elastic body are made of different materials and are integrally formed by double injection.

3. The electronic device according to claim 2, wherein the button body is made of a light-transmissive plastic material, and the elastic body is made of a soft material.

4. The electronic device according to claim 3, wherein the button body has at least one light-transmissive pattern.

5. The electronic device according to claim 4, wherein the light-transmissive pattern is formed by printing, screen printing, or spraying.

6. The electronic device according to claim 4, further comprising:
at least one light-emitting element electrically coupled to the circuit board, and a light emitted from the light-emitting element passing through the light-transmissive pattern.

7. The electronic device according to claim 1, further comprising:
at least one fixing element abutting against the button structure.

8. The electronic device according claim 1, wherein the elastic body has at least one positioning structure, and the at least one positioning structure being interlocked with the housing.

9. The electronic device according to claim 1, wherein the elastic body comprises:
a body portion carrying the button body;
an elastic arm connecting the body portion; and
an outer edge portion connecting the elastic arm, and the outer edge portion being connected to the inner surface of the housing with the waterproof adhesive.

10. A button structure disposed at an opening of an electronic device, the button structure comprising:
a button body exposed from the opening; and
an elastic body integrally formed with the button body as a single component.

11. The button structure according to claim 10, wherein the button body and the elastic body are made of different materials and are integrally formed by double injection.

12. The button structure according to claim 11, wherein the button body is made of a light-transmissive plastic material, and the elastic body is made of a soft material.
